(19) United States
(12) Patent Application Publication
(10) Pub. No.: US 2007/0095741 A1
(43) Pub. Date: May 3, 2007

(54) Filter module

(76) Inventor: Hendrik Johan Ferdinand Berends, Nijverdal (NL)

Correspondence Address: HARNESS, DICKEY & PIERCE, P.L.C., P.O. BOX 8910, RESTON, VA, 20195, US

(21) Appl. No.: 10/534,724

(22) PCT Filed: Oct. 31, 2003
(86) PCT No.: PCT/NL03/00752

§ 371 Date: Nov. 22, 2006

(51) Int. Cl. B01D 63/00

(52) U.S. Cl. 210/321.6; 210/459; 210/232; 29/896.62

(57) ABSTRACT

The invention relates to a filter module comprising: a housing with a first open end and a second open end; membrane holders which are arranged in the housing for the purpose of containing membranes which extend substantially between the first open end and the second open end, wherein the membrane holders are arranged on the inner wall of the housing. The invention further relates to a method for assembling a filter module according to any of the foregoing claims, which method comprises the steps of: providing an assembling device which comprises a number of elongate basic elements hingedly connected to each other in longitudinal direction; providing membrane holders; filling the membrane holders with membranes; arranging the filled membrane holders slidably on the basic elements; folding together the arranged membrane holders; and sliding the filled membrane holders from the basic elements into the filter housing.

The invention relates to a filter module. Such filter modules are used to arrange membranes in a pipe, so that for instance drinking water can be filtered. A filter module contains hollow capillary membranes, the walls of which are porous. Liquid for filtering flows into the membranes and is drained through the porous wall. Contaminants are then left behind in this wall.

In the manufacture of these filter modules the membranes are placed in a housing, whereupon a synthetic resin is arranged in the ends of the module in order to fix the membranes. The end surfaces are then sawn off, so that the membranes remain fixed but flow therethrough is now possible.

During placing the membranes are held in position by a holder. This holder ensures that the membranes are positioned such that water flowing radially out of the membranes can leave the filter module.

Different holders are known that can position the membranes. These holders are normally filled with membranes and then pushed into the housing of the filter module, whereafter the synthetic resin is arranged.

It is a problem to automate filling of these holders and placing of the holder in the housing. The operations required to enclose the membranes in the holder and subsequently position the holder relative to the housing, and to then push the holder into the housing are difficult to automate.

It is therefore an object of the invention to provide a filter module which can be easily filled with membranes and wherein these filling operations can be readily automated.

This object is achieved according to the invention with a filter module comprising:
a housing with a first open end and a second open end;
membrane holders which are arranged in the housing for the purpose of containing membranes which extend substantially between the first open end and the second open end, wherein the membrane holders are arranged on the inner wall of the housing.

Because the membrane holders are arranged on the inner wall, each membrane holder can be filled separately with membranes and arranged separately in the housing. This simplifies the operations for filling the whole housing of a filter module with membranes.

In one embodiment of the filter module according to the invention the membrane holders comprise a number of elongate sides which are mutually connected via the longitudinal sides.

In a preferred embodiment of a filter module according to the invention, at least two longitudinal sides of a membrane holder can be disconnected from each other in order to bend open the membrane holder. This simplifies automatic filling of such a holder. The holder can then be bent open, whereafter the membranes can be placed in the holder and do not have to be pushed therein in longitudinal direction.

In another preferred embodiment according to the invention, at least one of the elongate sides comprises a channel extending in lengthwise direction. Such a channel can be used as bypass of the filter module. In the case where a number of modules is placed successively in a pipe, it is advantageous to allow some of the liquid for cleaning to pass through to modules lying further to the rear. The flow resistance of a filter installation with such modules is hereby decreased. Membranes are periodically cleaned by reversing the flow direction in the filter module. In this situation the bypass serves for a rapid draining of flushing water with residue.

In yet another embodiment the elongate sides are at least partially perforated. The liquid flowing radially out of the membranes can hereby flow away more easily.

In a further embodiment spacers are arranged on the elongate sides to ensure a predetermined distance between membrane holders. The flow resistance of a module is hereby also decreased.

In yet another preferred embodiment, the membrane holders are arranged on the inner wall of the housing by means of coupling means.

The coupling means preferably comprise at least one rib extending in lengthwise direction and the membrane holders comprise at least one groove extending in lengthwise direction. The holders can hereby be pushed into the housing in lengthwise direction.

The coupling means can comprise at least two ribs extending in lengthwise direction, wherein at least one membrane holder is provided on either side with grooves extending in lengthwise direction, wherein the distance between the grooves is substantially equal to the distance between the ribs.

The invention further comprises a method for assembling a filter module according to the invention, which method comprises the steps of:
providing an assembling device which comprises a number of elongate basic elements hingedly connected to each other in longitudinal direction;
providing membrane holders;
filling the membrane holders with membranes;
arranging the filled membrane holders slidably on the basic elements;
folding together the arranged membrane holders; and
sliding the filled membrane holders from the basic elements into the filter housing.

With such a method the holders can be readily filled and arranged on the assembling device. All membrane holders can preferably then be pushed into the housing in one operation.

These and other features of the invention are further elucidated with reference to the annexed drawings.

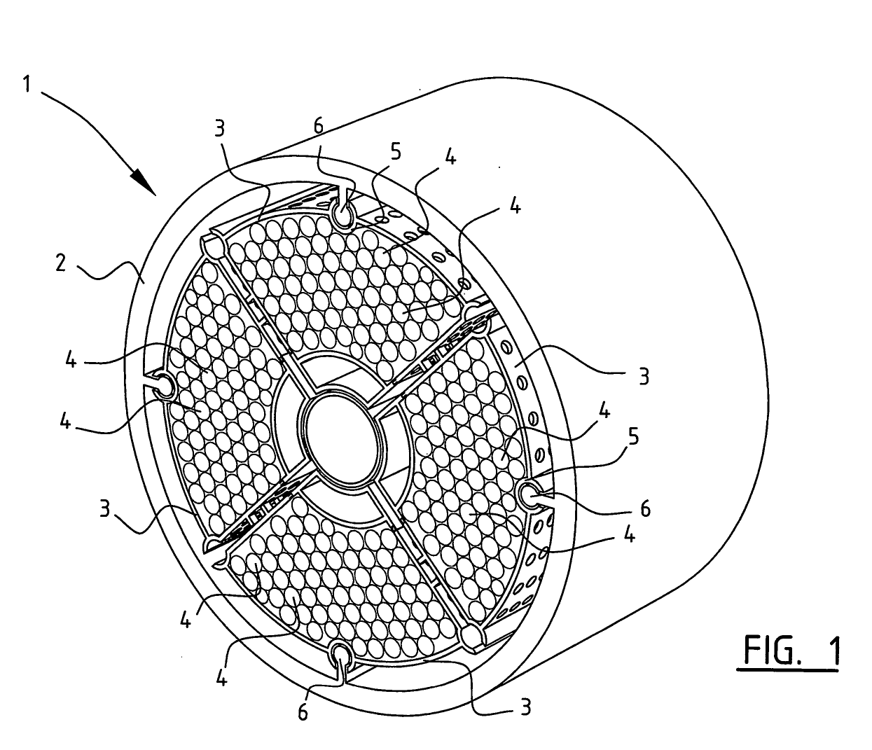

FIG. 1 shows a perspective view of an embodiment of a filter module according to the invention.

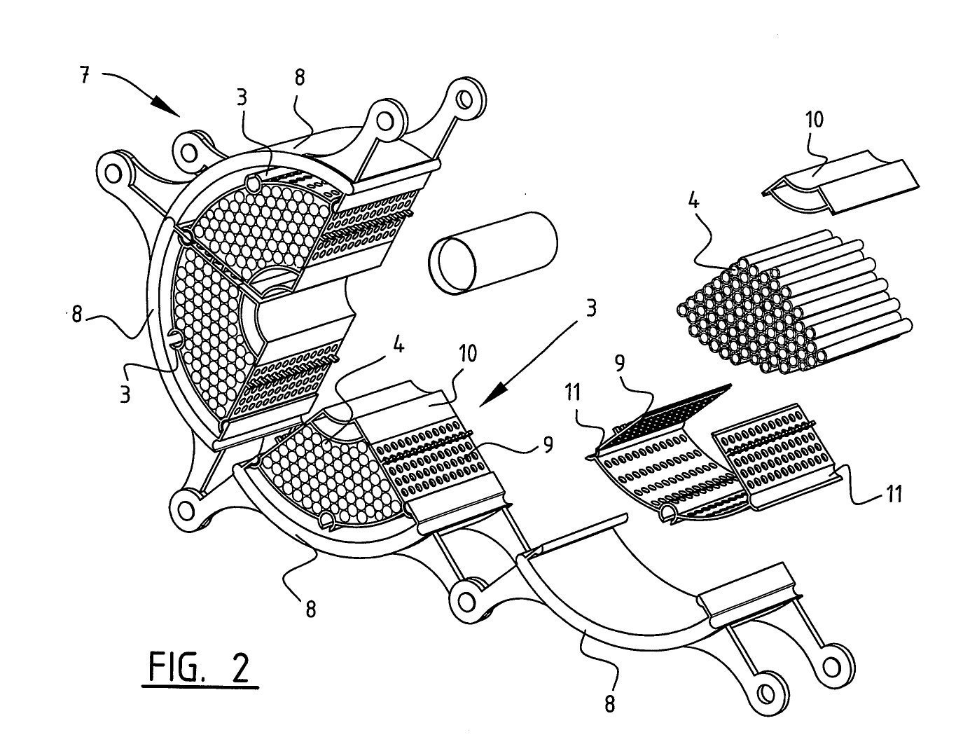

FIG. 2 shows a perspective view of a device for assembling a filter module according to the invention.

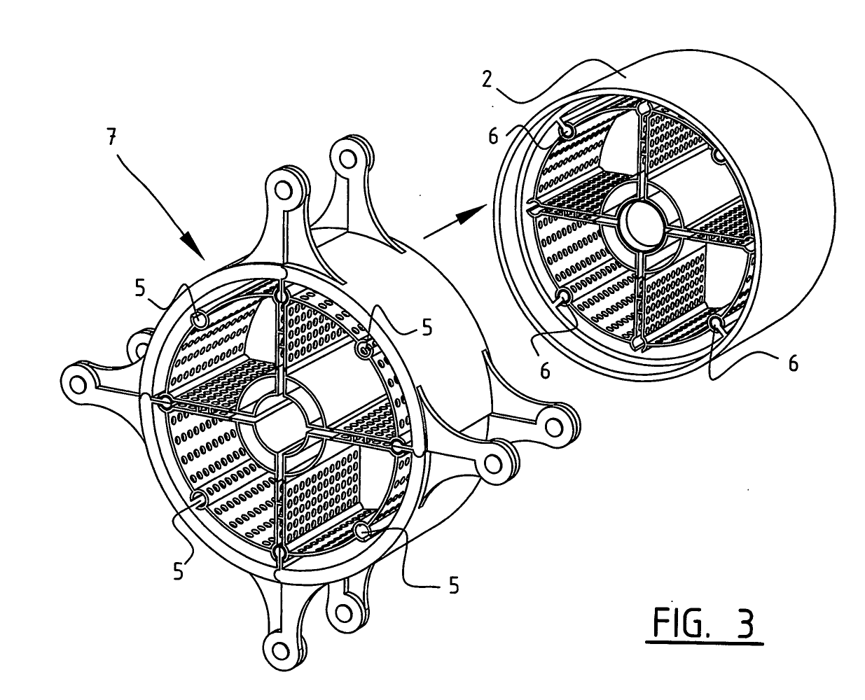

FIG. 3 shows the assembling device of FIG. 2 in a closed position.

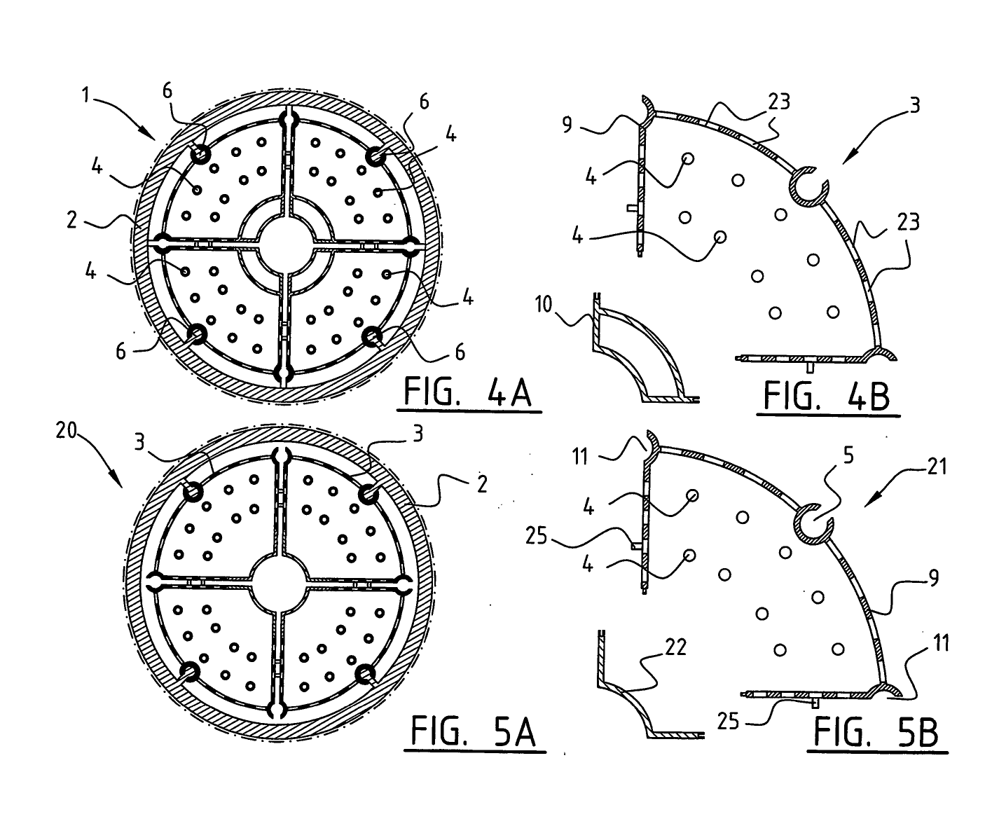

FIGS. 4A and 4B show a second embodiment of a filter module according to the invention.

FIGS. 5A and 5B show the embodiment of the filter module according to FIGS. 1-3.

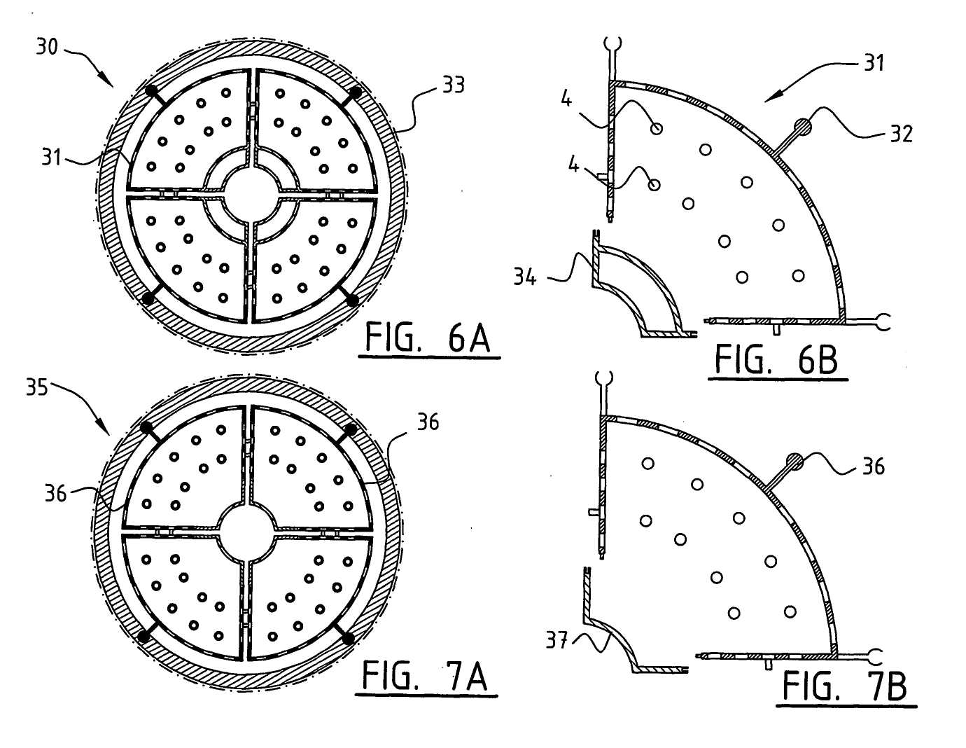

FIGS. 6A and 6B show a third embodiment of a filter module according to the invention.

FIGS. 7A and 7B show a fourth embodiment of a filter module according to the invention.

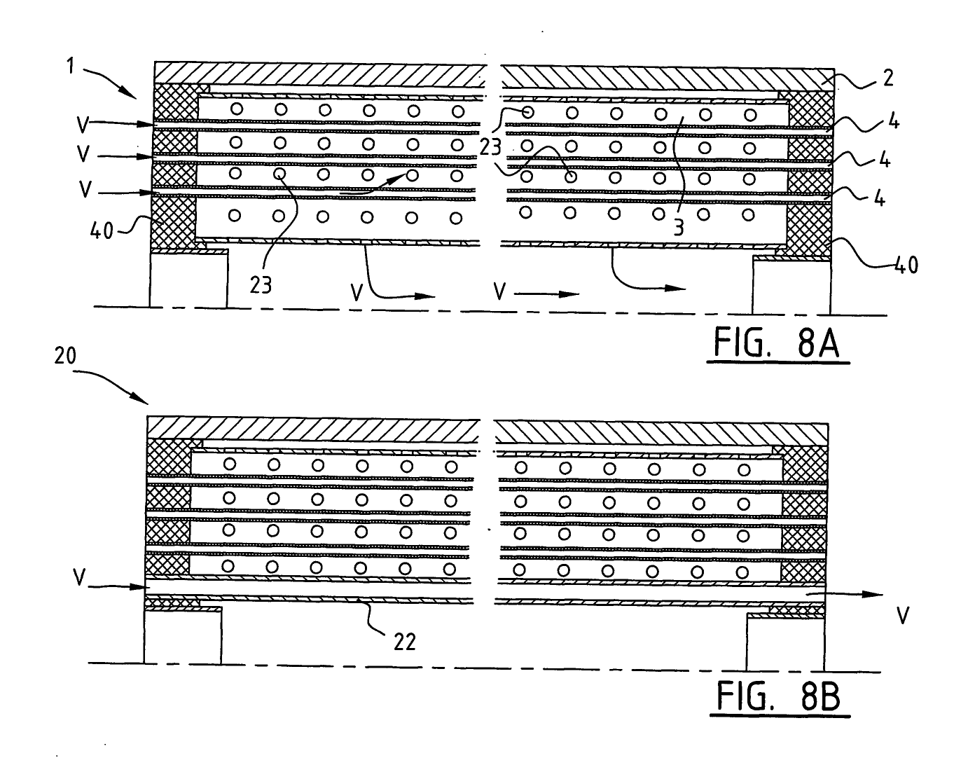

FIGS. 8A and 8B show in longitudinal section two embodiments of a filter module according to the invention.

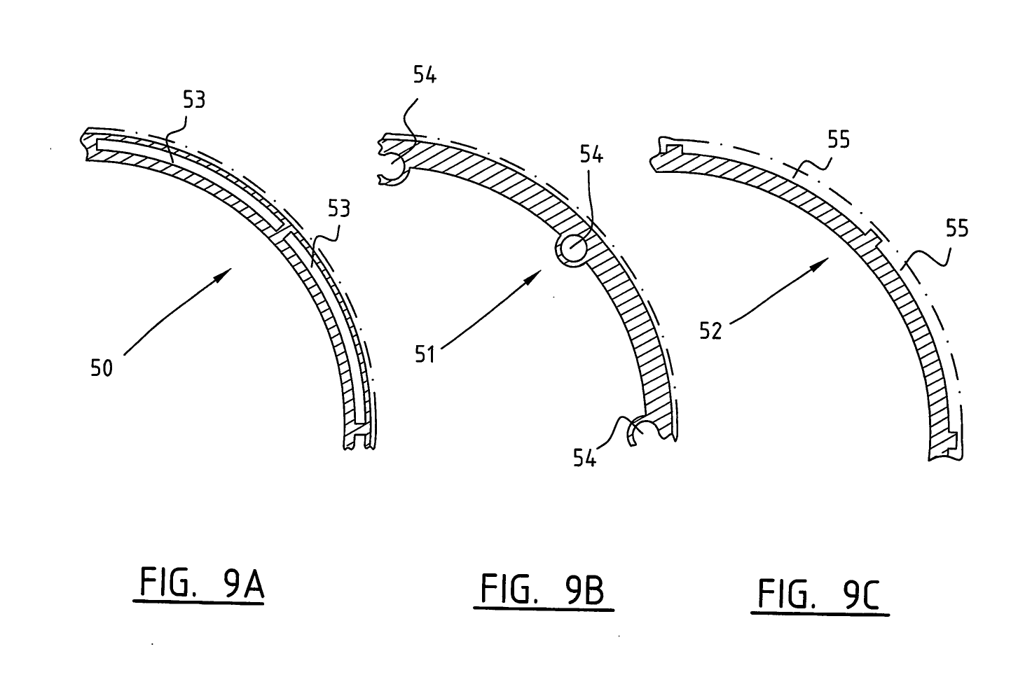

FIGS. 9A, 9B and 9C show three embodiments of a tube for a filter module according to the invention.

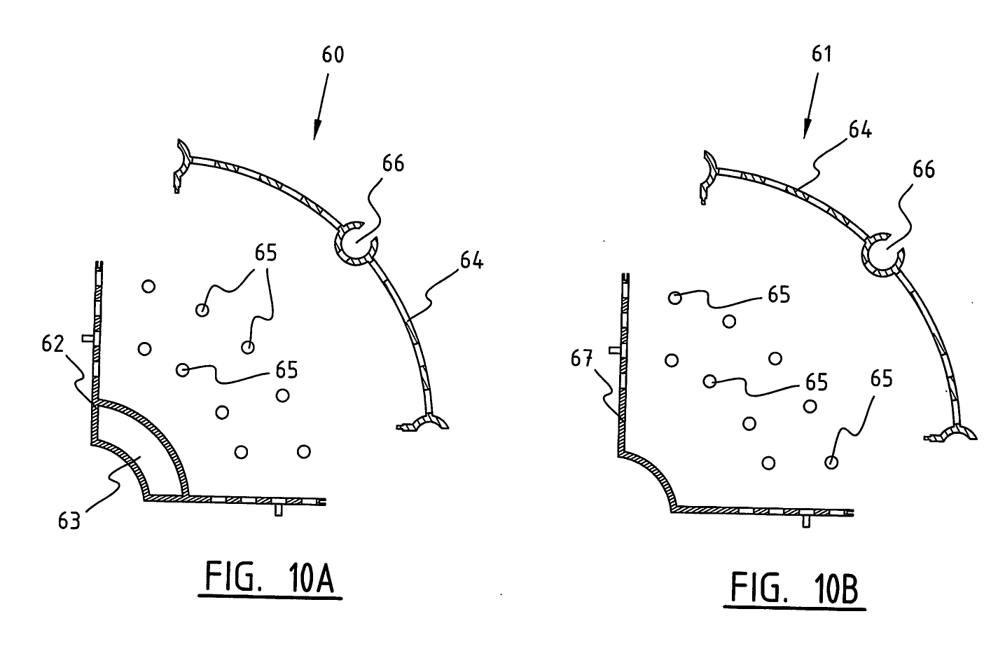

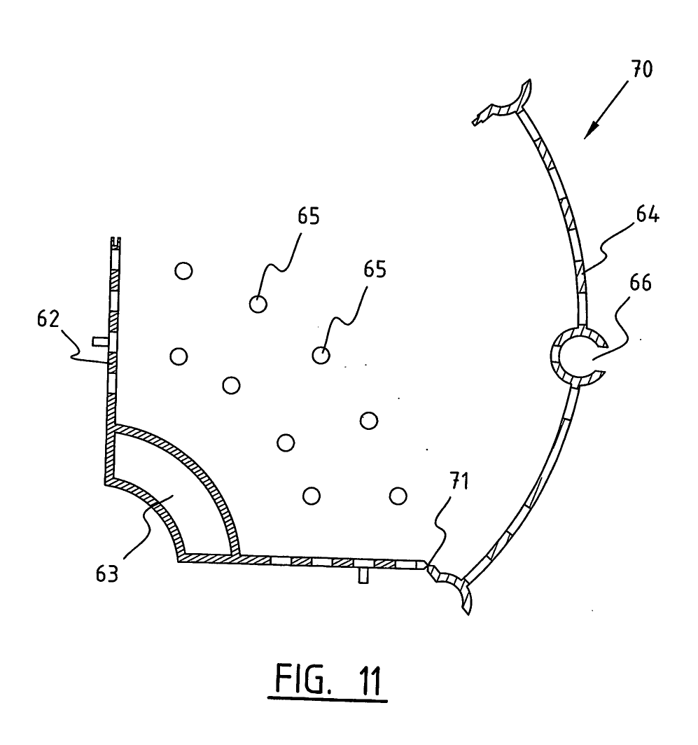

FIGS. 10A and 10B show a fifth embodiment of a filter module according to the invention.

FIG. 11 shows a sixth embodiment of a filter module according to the invention.

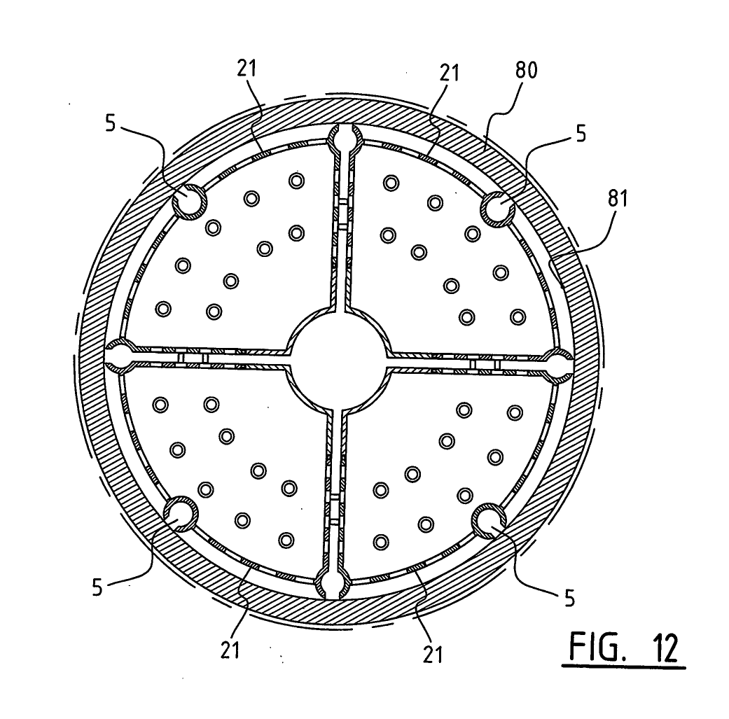

FIG. 12 shows a pipe with a filter module placed therein.

FIG. 1 shows a first embodiment of a filter module 1 according to the invention. This filter module 1 has a housing 2. Arranged in housing 2 are membrane holders 3 in which a large number of membranes 4 are placed. Each holder 3 has a groove 5 with which holder 3 is arranged on an associated rib 6 on the inside of the housing.

FIG. 2 shows an assembling device 7 with which a filter holder 3 can be filled with membranes 4. In this embodiment the assembling device 7 has four parts 8 hingedly connected to each other on which one holder 3 can be arranged in each case. Each holder consists of a first part 9 of three sides which can be bent outward to enable placing of membranes 4 into parts 9. The first part 9 of holder 3 is closed with a longitudinally extending hollow cap 10. This hollow cap 10 also forms a bypass channel, as will be further elucidated hereinbelow. The first parts 9 are provided on either side with a groove 11 with which the holders 3 can be held slidably on assembling device 7.

In FIG. 3 assembling device 7 is shown in closed position. Assembling device 7 is then positioned in front of housing 2 such that grooves 5 of holders 3 are in line with ribs 6. The filled holders 3 can then be pushed as a body into housing 2.

The embodiment of FIGS. 1-3 is shown in FIGS. 4A and 4B.

The membrane holders 3 consist of a first part 9 and a cap 10 arranged thereon. This cap 10 is hollow such that a bypass is provided in the filter module. The first part 9 is provided with openings 23 such that liquid streaming radially out of membranes 3 can flow easily out of holder 3.

The membrane holders 21 according to a second embodiment are shown in FIGS. 5A and 5B. Elements corresponding with filter module 1 are designated herein with the same reference numerals. Spacers 25 are arranged on the outside of membrane holders 21 so that a certain distance is ensured between the different membrane holders 21, and draining of the filtered liquid is not greatly impeded.

A third embodiment of a filter module 30 according to the invention is shown in FIGS. 6A and 6B. This filter module 30 largely corresponds with foregoing embodiments. Filter module 30 however has membrane holders 31 which are provided with ribs 32 which are guided in grooves of housing 33. Membrane holders 31 are provided with a hollow cap 34.

A fourth embodiment of a filter module 35 according to the invention is shown in FIGS. 7A and 7B. This filter module 35 is distinguished from filter module 30 in that the holders 36 have a cap 37 which is not hollow.

FIG. 8A shows a filter module 1 in cross-section. This filter module 1 has a housing 2 having arranged therein membrane holders 3 and membranes 4. Both ends of housing 2 are sealed by means of synthetic resin plugs 40. The membranes 4 protrude through these plugs 40 so that liquid V for cleaning can be supplied. Liquid V flows radially out of the membranes 4 and enters holders 3. Liquid V can then flow through perforations 23 to the central drainage channel 41.

FIG. 8B shows the filter module 20. This is distinguished from the embodiment shown in FIG. 8A in that a bypass channel 22 is provided which extends through both plugs. Liquid V for cleaning can flow directly via this channel to a filter module located further to the rear, whereby the flow resistance is not increased.

In FIGS. 9A-9C are shown three different embodiments of housings 50, 51 and 52 for a filter module according to the invention. These housings 50, 51, 52 have a hollow wall. These cavities 53, 54, 55 respectively can be used as bypass channel.

Cavities 55 of housing 52 form, with the pressure vessel in which such a filter module is placed, such a bypass channel.

FIGS. 10A and 10B show a further embodiment of a membrane holder 60, 61 for a filter module according to the invention. Membrane holder 60 consists of a first part 62 provided with a channel 63 which can function as bypass. A cap 64 is placed on part 62 so that membranes 65 can be held between cap 64 and part 62. The sides of part 62 and cap 64 are perforated. Further provided on cap 64 is a groove 66 with which the membrane holder can be fixed to the inner side of a pipe.

FIG. 10B shows a variant of a membrane holder 61. This membrane holder 61 corresponds for the greater part with membrane holder 60. The difference is that a bypass channel is no longer provided in part 67.

FIG. 11 shows yet another membrane holder 70 according to the invention. This membrane holder 70 corresponds for the greater part with membrane holder 60 of FIG. 10A. Corresponding parts are therefore designated with the same reference numerals. In membrane holder 70 the part 62 and the cover 64 are connected hingedly to each other via a linear hinge 71. This hinge can be mechanical, elastic or a film hinge.

FIG. 12 shows a filter module which is placed in a pipe 80. The filter module is constructed from membrane holders which are the same as the membrane holders 21 according to FIG. 5B. Pipe 80 is not provided with ribs on the inside, but the interior dimensions of pipe 80 are chosen such that in the inserted situation the membrane holders 21 fit snugly against the inner wall 81 of pipe 80 and also fit closely against each other.

The embodiment of FIG. 12 can be assembled very easily with an assembling device as shown in FIGS. 2 and 3. Grooves 5 of membrane holders 21 are used to hold the individual membrane holders 21 on the assembling device 7. From this assembling device 7 they can be pushed directly into pipe 80 such that the different membrane holders 21 fit snugly against each other and against the inner wall 81 of pipe 80.

1. Filter module comprising:
a housing with a first open end and a second open end;
membrane holders which are arranged in the housing for the purpose of containing membranes which extend substantially between the first open end and the second open end, wherein the membrane holders are arranged on the inner wall of the housing.

2. Filter module as claimed in claim 1, wherein the membrane holders comprise a number of elongate sides which are mutually connected via the longitudinal sides.

3. Filter module as claimed in claim 2, wherein at least two longitudinal sides of a membrane holder can be disconnected from each other in order to bend open the membrane holder.

4. Filter module as claimed in claim 2, wherein, at least one of the elongate sides comprises a channel extending in lengthwise direction.

5. Filter module as claimed in claim 2, wherein the elongate sides are at least partially perforated.

6. Filter module as claimed in claim 2, wherein spacers are arranged on the elongate sides to ensure a predetermined distance between membrane holders.

7. Filter module as claimed in claim 1, wherein the membrane holders are arranged on the inner wall of the housing via at least one coupling device.

8. Filter module as claimed in claim 7, wherein the at least one coupling device comprises at least one rib extending in lengthwise direction and the membrane holders comprise at least one groove extending in lengthwise direction.

9. Filter module as claimed in claim 7, wherein the at least one coupling device comprises at least two ribs extending in lengthwise direction, and at least one,membrane holder is provided on either side with grooves extending in lengthwise direction, wherein the distance between the grooves is substantially equal to the distance between the ribs.

10. Filter module comprising:
a housing with a first open end and a second open end;
membrane holders which are arranged in the housing for the purpose of containing membranes which extend substantially between the first open end and the second open end, wherein the membrane holders lie against each other and against the inner wall.

11. Method for assembling a filter module the method comprising:
providing an assembling device which comprises a number of elongate basic elements hingedly connected to each other in longitudinal direction;
providing membrane holders;
filling the membrane holders with membranes;
arranging the filled membrane holders slidably on the basic elements;
folding together the arranged membrane holders; and
sliding the filled membrane holders from the basic elements into the filter housing.

12. Filter module as claimed in claim 3, wherein at least one of the elongate sides comprises a channel extending in lengthwise direction.

13. Filter module as claimed in claim 3, wherein the elongate sides are at least partially perforated.

14. Filter module as claimed in claim 12, wherein the elongate sides are at least partially perforated.

15. Filter module as claimed in claim 14, wherein spacers are arranged on the elongate sides to ensure a predetermined distance between membrane holders.

16. Filter module as claimed in claim 15, wherein the membrane holders are arranged on the inner wall of the housing via at least one coupling device.

17. Filter module as claimed in claim 16, wherein the at least one coupling device comprises at least one rib extending in lengthwise direction and the membrane holders, comprise at least one groove extending in lengthwise direction.

18. Filter module as claimed in claim 16, wherein the at least one coupling device comprises at least two ribs extending in lengthwise direction, and at least one membrane holder is provided on either side with grooves extending in lengthwise direction, wherein the distance between the grooves is substantially equal to the distance between the ribs.

19. Method for assembling a filter module as claimed in claim 1, the method comprising:
providing an assembling device which comprises a number of elongate basic elements hingedly connected to each other in longitudinal direction;
providing membrane holders;
filling the membrane holders with membranes;
arranging the filled membrane holders slidably on the basic elements;
folding together the arranged membrane holders; and
sliding the filled membrane holders from the basic elements into the filter housing.

20. Method for assembling a filter module as claimed in claim,10, the method comprising:
providing an assembling device which comprises a number of elongate basic elements hingedly connected to each other in longitudinal direction;
providing membrane holders;
filling the membrane holders with membranes;
arranging the filled membrane holders slidably on the basic elements;
folding together the arranged membrane holders; and
sliding the filled membrane holders from the basic elements into the filter housing.
